(19) United States
(12) Patent Application Publication
(10) Pub. No.: US 2012/0072358 A1
(43) Pub. Date: Mar. 22, 2012

(54) CUSTOMER CARE REPLIES ON SOCIAL MEDIA

(75) Inventors: Tod Famous, Ayer, MA (US); Michael Lepore, Marlborough, MA (US)

(73) Assignee: Cisco Technology, Inc., San Jose, CA (US)

(21) Appl. No.: 12/883,983

(22) Filed: Sep. 16, 2010

(51) Int. Cl. G06Q 99/00

(52) U.S. Cl. 705/319

(57) ABSTRACT

In one implementation, customer service is managed by a contact center. The contact center includes a contact center server and an agent device. The contact center server monitors external social media to identify a social media post by a customer. The social media post may be filtered by the customer names, product identities, and/or the nature of the post. The contact center server accesses a database storing a plurality of agent identities and searches the social media for a reply to the customer's social media post. Replies may be identified using subject line or a reply indicator. The contact center server stores the reply to the social media post.

### FIELD

The present embodiments relate to customer service.

### BACKGROUND

Customer call centers field customer calls for technical support, warranty, or other assistance. The customers may be indexed by the customer's phone number, account number, or other identifying information may be used to access the customer's record in a database. The database is populated with information given to the customer call center by the customer. When the problem is resolved, any actions or resolutions are entered into the database by the contact center agent.

### BRIEF DESCRIPTION OF THE DRAWINGS

FIG. 1 illustrates one embodiment of a customer contact center.

FIG. 2 illustrates an agent desktop in the customer contact center of FIG. 1.

FIG. 3 illustrates example out of band replies using social media.

FIG. 4 illustrates another view of the agent desktop of FIG. 2.

FIG. 5 illustrates a customer database coupled with the customer contact center of FIG. 1.

FIG. 6 illustrates an agent database coupled with the customer contact center of FIG. 1.

FIG. 7 illustrates one embodiment of a flow chart of customer care utilizing out of band replies on social media.

### DETAILED DESCRIPTION

### Overview

A contact center or call center may communicate with customers using a variety of forms of communication. Traditional forms of communication such as email and telephone may be supplemented or replaced with communication through social media. The information available in social networking services is monitored by the contact center. Social media posts may be filtered to identify customer service issues, which trigger a workflow or ticket that is assigned to one or more agents of the contact center. The information a customer has provided in the social media posts may be used to initiate communication with the customer or as a starting point to save time when the customer directly communicates with the contact center.

The customer service agent may reply to the customer using the social networking service. In one implementation, the contact center may internally provide an avenue for communication between the customer service agent and the social networking service. Alternatively, the customer service agent may directly reply to the social media post on the social networking service. In this case, the contact center may monitor for replies and download, store, and/or display the identified replies. Accordingly, the contact center provides the customer service agent with flexibility and permits accurate reporting and monitoring of the replies.

In one aspect, a method includes monitoring at least one social medium to identify a social media post by a customer on the at least one social medium, accessing a database storing a plurality of agent identities, searching the at least one social medium for a reply to the social media post, the reply associated with one of the plurality of agent identities, and storing the reply to the social media post.

In a second aspect, an apparatus includes a communication interface operable to receive a passive customer service request by monitoring a social networking service, a database storing one or more agent identities associated with the customer identity, and a controller configured to query at least one social networking service using the one or more agent identities.

In a third aspect, logic encoded in one or more non-transitory tangible media is executable by a processor and operable to access a database storing a plurality of agent identities and a plurality of customer identities, monitor at least one social medium to identify a social media post associated with one of the customer identities, open a workflow based on the social media post, monitor the at least one social medium to identify a social media reply associated with one of the agent identities, and close the workflow based on the social media reply.

### Example Embodiments

Social media hosts provide social network services. A social network service may be any service in which the content is generated by the users. Many social network services are websites accessed through a uniform resource locator (URL). Social network services may include a “profile” or “page” for each user to add content, and each user shares the user's profile or page with other users. Some profiles are public and accessible by anyone, while others are private and accessible only by selected other users, which may be referred to as friends or contacts.

Consumers use social network services to communicate. Often, this means that consumers post about the products they use, especially when they have a problem. For example, a cell phone customer may comment about poor reception in a particular area, or a television cable customer may comment that his service has been intermittent. Sometimes the posting may describe the particular problem in detail, including the location where the problem occurred, the date, the time of day, the brand/model of the device, and/or the service provider. A customer contact system that taps into the wealth of information available from social network services provides more efficient customer service to customers.

In addition, the information from social networking services may be used to initiate communication with customers. For example, the customer contact center may include a contact center server to monitor social networking services for customer service issues. When a customer posts a problem on a social networking service, the contact center server identifies the post and initiates a workflow or ticket to return information to the customer and resolve the problem. The contact center server may assign one or more agents to the workflow or ticket. In one implementation, the return communication to the customer may simply be a phone call or an email from a contact center agent. The return communication may be recorded by the agent or automatically recorded by the contact center server.

Customers may prefer to receive communication in the same medium of the original posts. In other words, the agent may access the social networking service using the agent's or company's name to respond to the problem of the customer. This reply may be posted using the contact center server if the server is integrated to the social networking service. Alternatively, the contact center agent may choose to reply directly on the website of the social networking site or by using an independent software client. This type of reply is out of band with respect to the customer contact system since the system may not involved in posting the reply. The contact center server may seek out these out of band replies in order to build a complete record of the communication with the customer.

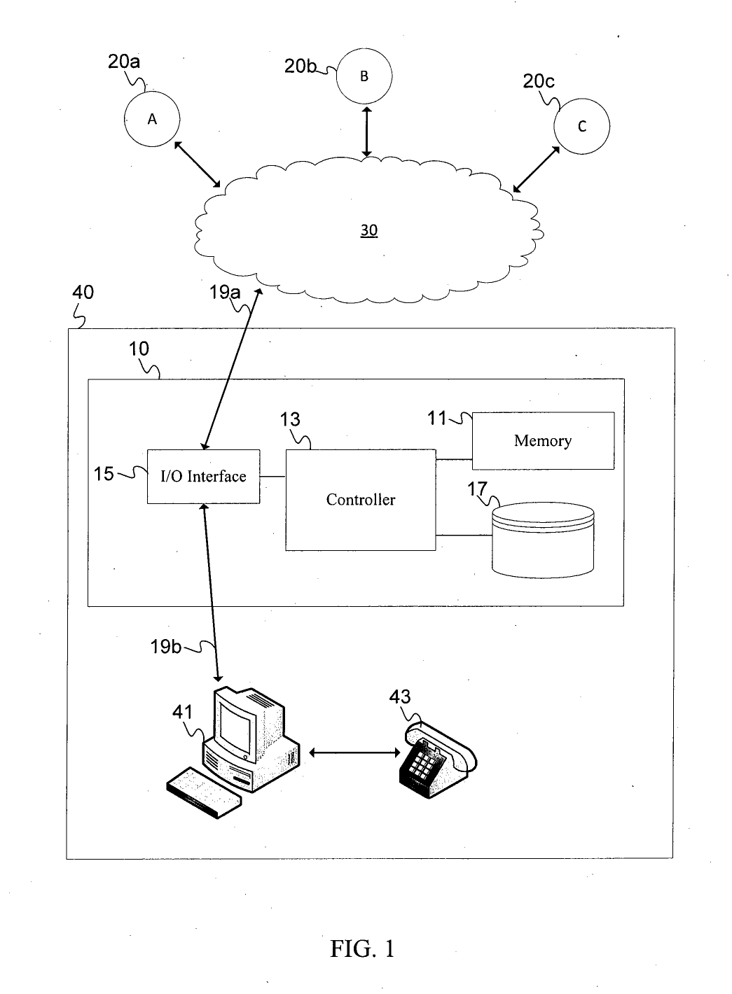

FIG. 1 illustrates a customer contact center 40 connected to a network 30 via communication path 19a. The network 30 may be the Internet or a local area network (LAN). The network 30 or communication path 19a provides access to social network services 20a-c. Additional or fewer social network services may be used. The customer contact center 40 includes a contact center server 10, which is connected to agent device 41. The customer contact center 40 may include agent phone 43; however, no phone or live communication is necessary. The contact center server 10 includes a controller 13, a memory 11, an input/output (I/O) interface 15 (communication interface), and a database 17. Alternatively, the contact center server 10 may be implemented as a personal computer. Additional, different, or fewer components may be provided.

The customer contact center 40 may receive communication from a customer in a variety of ways. The customer may communicate with the customer contact center 40 using telephone, email, instant message, text message or short message service (SMS), chat room, or another method.

The customer contact center 40 may receive a communication from a customer. The communication identifies the customer. For example, if the communication is telephone call, caller identification (ID) or an interactive voice response (IVR) system may be employed by the agent device 41 or contact center server 10 to identify the customer. The agent device 41 sends the customer identity to the contact center server 10 as a customer service request, and the I/O interface 15 receives the customer service request including the customer identity. The controller 13 is configured to access social media postings based on the customer identity. By way of I/O interface 15, the contact center server 10 transmits the social media postings to agent device 41.

In addition or alternatively, the contact center server 10 monitors social network services for relevant information from customers. The information harvested from social networking services may be considered a passive customer request because the customer is not directly contacting the customer contact center. Even though the passive customer request may intentionally contact a particular entity, the request is still considered passive because it is made through the social networking service rather than through direct communication. The contact center server 10 may filter the social media postings according to a product identity. The product identity may be a brand name, a service name, a model number or other keywords (e.g., any alphanumeric text, including only numbers, and/or symbols) indicative of a particular product or service or other mining criteria.

The contact center server 10 may monitor social network services periodically. For example, the monitoring may occur at a predetermined time, such as every night at midnight. The monitoring may also be limited to a list of known customers or by specific geographic regions.

In another implementation, the contact center server 10 accesses social media postings on the fly, when a direct contact customer service request is received. The controller 13 may access the social media postings based on a trigger. The trigger may be a communication from the customer in the form of a telephone call, email, text message, or chat request.

In any of the various implementations regarding how the contact center accesses the customer social media posts, the controller 13 is configured to access social networking services for replies to the customer social media posts. As will be discussed in greater detail below, the controller 13 may monitor social networking services for any replies to customer social media posts using one or both of two methods. First, the controller 13 may initiate a search based on a reply indicator, which includes terms such as “reply” and “@”. In addition, the controller 13 may monitor social networking services for any posts by an agent of the customer contact center 40 by initiating a search based on a list of one or more agent identities. While either method may be used, the combination may provide a comprehensive list of all agent replies to customer social media posts.

In one example, the contact center server 10 may include an operating system and a software application. The operating system may be Linux based, Windows based, or another system. The contact center server 10 may be implemented as a virtual machine.

The memory 11 may be any known type of volatile memory or a non-volatile memory. The memory 11 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory. The memory 11 may include an optical, magnetic (hard drive) or any other form of data storage device. The memory 11 may be located in a remote device or removable, such as a secure digital (SD) memory card.

The database 17 may be external to the contact center server 10 or incorporated within the contact center server 10. The database 17 may be stored with memory 11 or separately. The database 17 may be implemented as either hardware or software.

The memory 11 may store computer executable instructions. The controller 13 may execute computer executable instructions. The computer executable instructions may be included in computer code. The computer code may be stored in the memory 11. The computer code may be written in any computer language, such as C, C++, C#, Java, Pascal, Visual Basic, Perl, HyperText Markup Language (HTML), JavaScript, assembly language, extensible markup language (XML) and any combination thereof.

The computer code may be logic encoded in one or more tangible media or one or more non-transitory tangible media for execution by the controller 13. Logic encoded in one or more tangible media for execution may be defined as instructions that are executable by the controller 13 and that are provided on the computer-readable storage media, memories, or a combination thereof. Instructions for instructing a network device may be stored on any logic. As used herein, “logic,” includes but is not limited to hardware, firmware, software in execution on a machine, and/or combinations of each to perform a function(s) or an action(s), and/or to cause a function or action from another logic, method, and/or system. Logic may include, for example, a software controlled microprocessor, an ASIC, an analog circuit, a digital circuit, a programmed logic device, and a memory device containing instructions.

The instructions may be stored on any computer readable medium. A computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 13 may include a general processor, digital signal processor, application specific integrated circuit, field programmable gate array, analog circuit, digital circuit, server processor, combinations thereof, or other now known or later developed processor. The controller 13 may be a single device or combinations of devices, such as associated with a network or distributed processing. Any of various processing strategies may be used, such as multi-processing, multi-tasking, parallel processing, remote processing, centralized processing or the like. The controller 13 may be responsive to or operable to execute instructions stored as part of software, hardware, integrated circuits, firmware, micro-code or the like. The functions, acts, methods or tasks illustrated in the figures or described herein may be performed by the controller 13 executing instructions stored in the memory 11. The functions, acts, methods or tasks are independent of the particular type of instructions set, storage media, processor or processing strategy and may be performed by software, hardware, integrated circuits, firmware, micro-code and the like, operating alone or in combination. The instructions are for implementing the processes, techniques, methods, or acts described herein.

The I/O interface 15 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. For example, the I/O interface 15 may comprise a first communication interface devoted to sending data, packets, or datagrams and a second communication interface devoted to receiving data, packets, or datagrams. Alternatively, the I/O interface 15 may be implemented using a single communication interface.

The communication paths 19a-b may be any protocol or physical connection that is used to couple a server to a computer. The communication paths 19a-b may utilize Ethernet, wireless, or TCP/IP technologies. As used herein, the phrases “in communication” and “coupled” are defined to mean directly connected to or indirectly connected through one or more intermediate components. Such intermediate components may include both hardware and software based components.

The agent device 41 may be a personal computer also including a processor and a memory according to the alternatives above. The agent device 41 may execute software displaying the social media postings accessed by controller 13. The agent device 41 may access a website using a hypertext transfer protocol (HTTP) browser by accessing a URL on contact center server 10. Alternatively, the contact center server 10 and the agent device 41 may be implemented as a single personal computer or server.

The agent phone 43 may be an IP phone. In one example, the agent phone 43 is integrated into the agent device 41. In another example, the agent phone 43 may be directly connected to the communication path 19b. Alternatively, the agent phone 43 may be coupled with a public switched telephone network (PSTN) and/or a private branch exchange (PBX), and the calls may be routed using a call center manager.

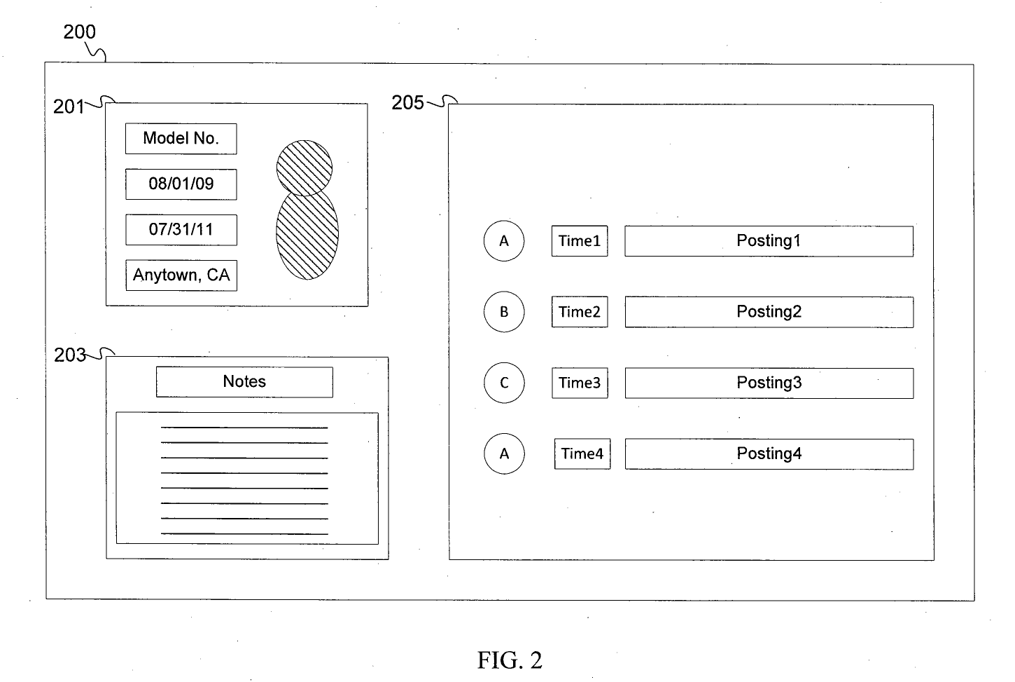

FIG. 2 illustrates an agent desktop 200 as displayed on agent device 41. The agent desktop 200 may be a software application running on the agent device 41 or a web-based application accessed by the agent device 41 and running on a server. The agent desktop 200 includes account information 201, call notes 203, and social media timeline 205. The agent desktop 200 may be a screen pop that is triggered by the customer's call being connected with agent phone 43 or triggered by a passive customer service request identified by monitoring social networking services. Different, additional, or fewer types of information may be provided. Other formats may be provided.

The account information 201 includes information related to customer and/or product, which may include information such as the model number, the purchase date, the end of contract date, the end of warranty date, the location of the purchase, the customer's balance, and/or the location of the customer. The account information 201 may include an image of the product or the customer, which may be downloaded from one or more of the social network services.

The call notes 203 include information added by the call agent during telephone calls. The call notes 203 may be indexed with a time stamp. The call notes 203 contain information obtained from a customer in one call that can be used by the call agent in the next call.

The social media timeline 205 includes one or more social media postings. The social media postings may be customer posts and/or agent replies. The social media postings are accessed from social networking services 20a-c. The social media postings may be presented in chronological order. For example, the social media postings from one or more of the various social network services may be interleaved according to timestamps. The social media timeline 205 is a timeline of the total activities, regardless of whether the activities are related, of a particular user. The social media timeline 205 is organized around the person. Other organizations may be used.

The social media postings may be limited by a configurable parameter. The configurable parameter may be a time range for the social media postings. The time range may be periodic, for example, once a day, a week, a month. The time range may be a predetermined time range or it may be set by the agent device 41. The contact center server 10 may filter the plurality of social media postings according to the configurable parameter.

In addition or in the alternative, the configurable parameter may be a relevance factor of the social media postings. The relevance factor may be determined by the contact center server 10 according to a set of keywords. The set of keywords may be chosen based on the words typically used by consumers in need of customer assistance. A Bayesian filter, such as that used in spam filtering, may be trained according to word probability functions to identity relevant social media posts.

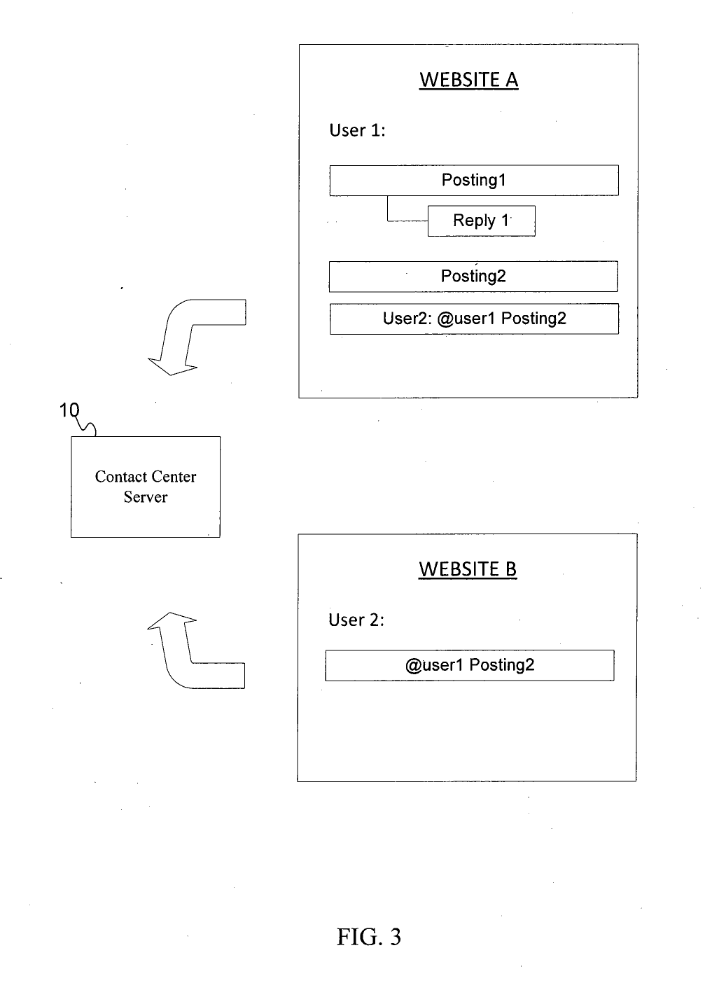

FIG. 3 illustrates a high level diagram for out of band replies. The contact center server 10 monitors at least one social networking service. The social networking service may be Website A, Website B, or both. A variety of specific procedures may be used to identify out of band replies.

In a first procedure, as shown by Website A, the contact center server 10 identifies the customer's original post (Posting 1) based on the customer's username, URL, email address, or other identification. The contact center server 10 then identifies any posts directed to that customer by any agent of the contact center. The contact center server 10 monitors posts from known agent identities, assuming such posts to be from the agents of the contact center. Alternatively, the contact center server 10 may identify any replies to Posting 1. Replies may be identified using various reply indicators. Reply indicators may include the term “reply,” “reply to,” “re:,” “@username,” a common subject or heading, or variations thereof. The subject line of the post may also be a reply indicator. Metadata, which may be defined as any information provided by the social networking service as opposed to directly entered by the user, may also be used as a reply indicator.

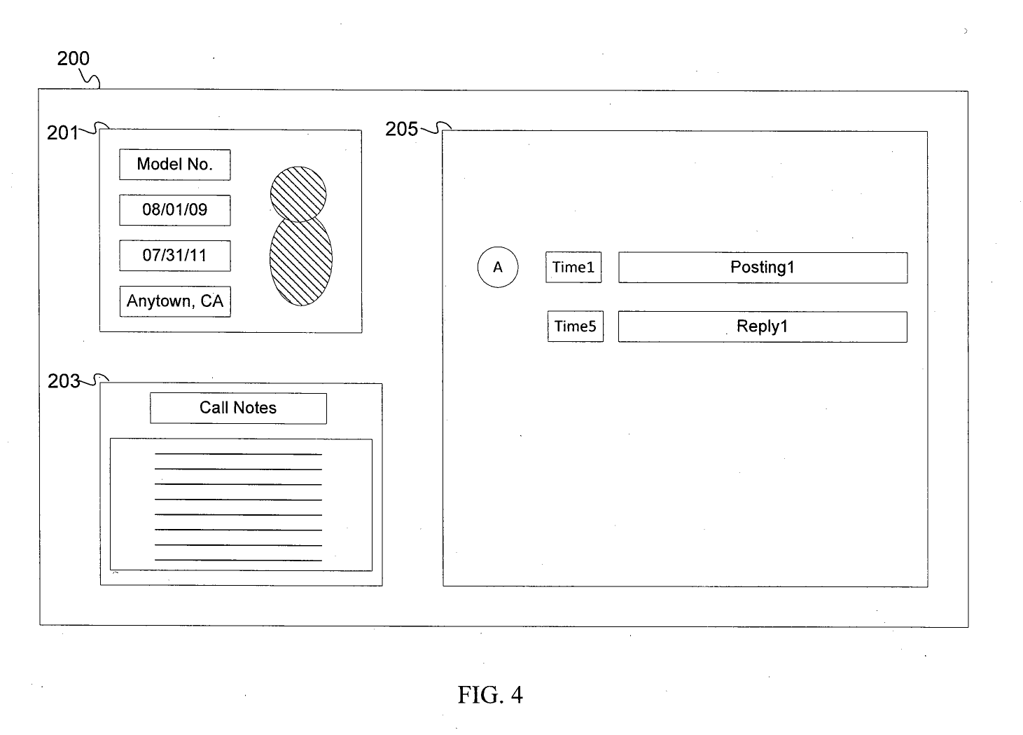

In a second procedure, as shown by Website B, the contact center server 10 may monitor only the social media posts of agents of the contact center, using a list of agent identities. The social media posts of agents that are replies to customer social media posts may be identified by the reply indicators in the agent's social media post. For example, FIG. 4 illustrates that agent User2 has replied to customer User1's Posting 2. Both the first procedure and the second procedure may be implemented in combination. According, the customer contact server 10 may be configured to identify duplicates that may appear in two locations (one linked to the agent and another linked to the customer).

FIG. 4 illustrates the agent desktop 200 as displayed on agent device 41 after the agent has posted a reply. The social media timeline 205 matches the customer original posting with the agent's reply. In other words, the customer contact server 10 may be configured to thread customer social media posts with agent replies on the same display. Accordingly, the agent, or the agent's supervisor, can monitor the agent replies side by side with customer posts. The agent replies may also be stored in database 17 or memory 11.

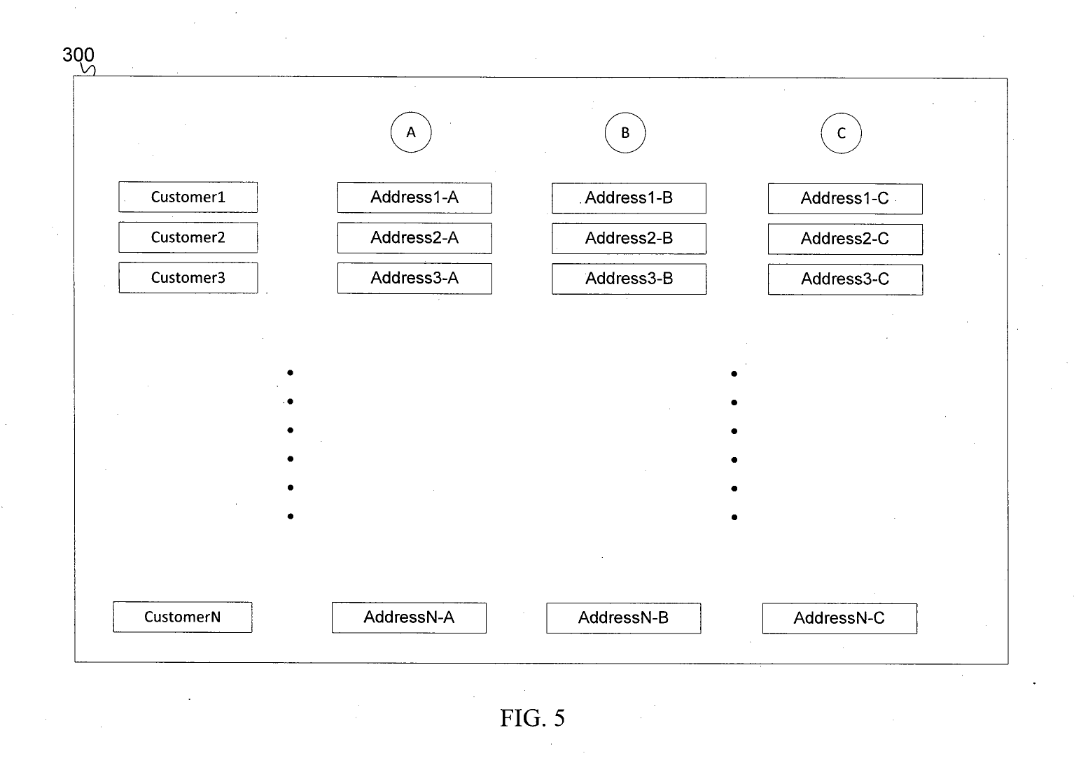

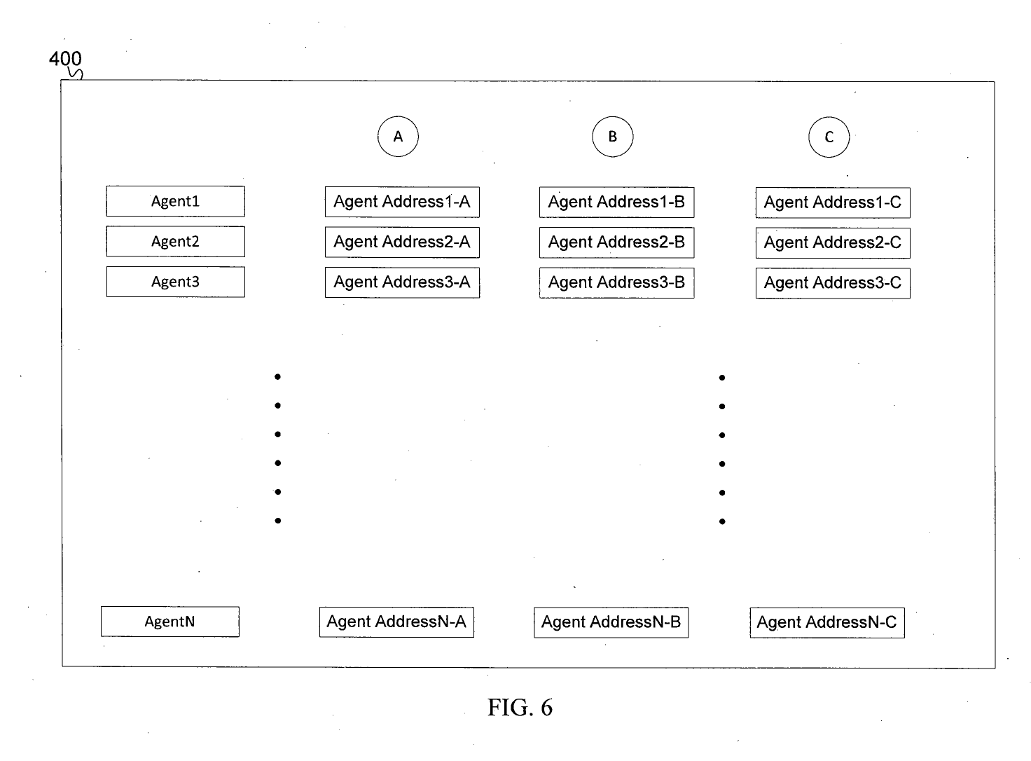

FIGS. 5 and 6 illustrate a customer address database 300 and an agent address database 400 coupled with the customer contact center of FIG. 1. The customer address database 300 and/or the agent database 400 may be stored in database 17 or memory 11. The customer address database 300 includes a list of customer identities. Each customer identity is matched with one or more social network services by username, URL, email address, or other identification. For example, customer1 may be an account number or customer name connected to Address1-A, which is a Facebook URL, Address1-B, which is a twitter ID, and Address1-C, which is a blog URL.

The agent address database 400 includes the list of agent identities, which also may be matched with one or more social network services by username, URL, email address, or other identification. For example, agent1 may be a an account number or customer name connected to Agent Address1-A, which is a Facebook URL, Agent Address1-B, which is a twitter ID, and Agent Address1-C, which is a Google Buzz account.

The contact center server 10 may query social media hosts using the address indexed by customer identity in customer address database 300, and the communication interface 15 transmits the social media postings to an external device, such as agent device 41.

Social media postings may be either public or private. Public postings may be accessed simply by knowledge of the customer's name or URL. The customer may disclose the location of public postings through a questionnaire email, a prompt on the IVR system, a warranty card, or by the request of the customer service agent. Public postings may even be located by simply using a search engine with the customer's name or other identification. Another example of public postings is “fanpages” popular on Facebook where customers create social media postings on the fanpage of a particular product, service, or company.

Private postings, on the other hand, may only be accessed with the customer's permission. However, the customer contact center may send an electronic request, such as a friend request, to the customer. The request may be sent in response to the customer disclosing that the customer uses social networking service in a questionnaire email, a prompt on the IVR system, a warranty card, in response to a communication to the contact center, or by the request of the customer service agent.

The customer contact center may have access to some private social media postings that were made on the vendor's web site. For example, some vendors may have forums or message boards where customers post about their successes and problems with products. Other customers or employees of the vendor help them via the message board. These social media postings are particularly relevant to the reason that the customer is contacting a contact center.

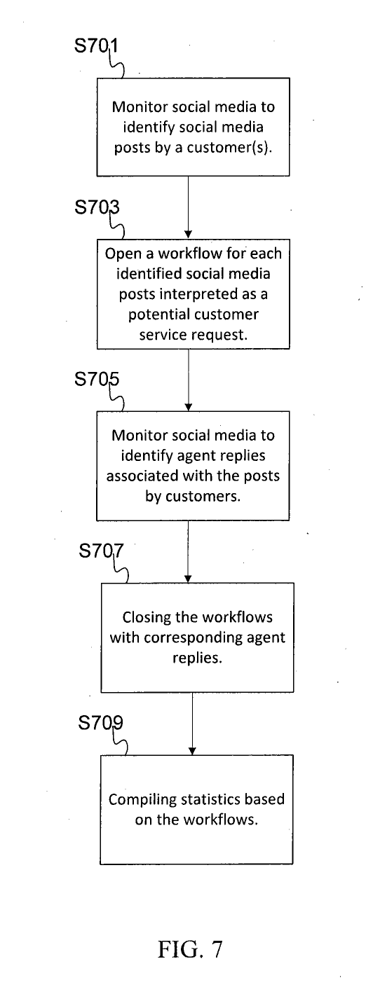

FIG. 7 illustrates a flow chart for out of band replies. At S701, the contact center server 10 monitors one or more social networking services for social media posts by customers. The social media posts may be identified by a known list of customers or by keyword associated with a product or service. The social media posts may be filtered. For example, the filter may identify social media posts have a negative attitude.

At S703, the contact center server 10 opens a workflow for each identified social media posts that is interpreted as a potential customer service request. That is, the contact center server 10 identifies social media posts with problems and tasks an agent to follow up with the customer. In many situations, the agent will send an email or place a telephone call through the contact center server 10. In these scenarios, the workflow may be automatically closed. In other situations, the agent may reply to the customer's social media post.

The workflows and the open or closed status of the workflows are stored in a customer workflow database. The workflow database may be implemented as part of database 17, and may be combined or separate from the customer address database 300 and/or the agent address database 400.

At S705, the contact center server 10 monitors social networking services to identify agent replies to the social media posts. The agent replies may be linked to an agent's username, which is accessed from the agent address database 400. The agent's replies may be linked to the customer's posts through a variety of ways, which include but are not limited to, subject line, or a reply indicator. At S707, the contract center server 10 closes the workflow that is associated with the identified agent reply. The agent replies are stored in database 17 or memory 11. Other actions may be taken, such as displaying the customer post and agent reply or displaying agent replies to different posts for monitoring agent performance.

At S709, the contact center server 10 may compile statistics based on the workflows. The statistics may include the average time from opening to closing workflows (workflow duration), the percentage of workflows closed within a certain time period, or the percentage of workflows requiring further follow up by the contact center (workflow effectiveness). The controller 13 may calculate workflow duration as the difference between a first timestamp associated with the passive customer service request and a second timestamp associated with the reply post by the agent.

The statistics may be displayed by agent device 41 or stored in database 17. In addition, the statistics may include a measure of the customer's subsequent actions. For example, the contact center server 10 may monitor subsequent social media posts for positive comments by the customer and measure the frequency that a particular agent's replies are followed by positive and/or negative social media posts by the customer.

Social network services take many forms, each allowing users to create social media postings. One form is a profile based social network service. In a profile based social network service, users create a profile as representations of themselves. The profiles often include photographs, likes and dislikes, and other user generated content. Many profiles also include a contact list used to connect to other users' profiles and access the other users' content. Profile based social network services focus on the relationships among people, which includes groups of people who share interests or are friends for any reason. Most profile based social network services are accessed via the Internet using a URL. The profile based social network establishes connections among users. Examples of profile based social networks include Facebook, MySpace, LinkedIn, and Bebo. Most profile based social networks include an area for comment by the user and by other users. In addition, many profile based social networks include a status message feature, which is an example of a microblog.

The microblog is another form of a social network service. A microblog entry includes an entry relatively small in content as compared with other sources. A microblog entry could consist of a sentence, a sentence fragment, an image, or an embedded video. The most common subject of microblog entries relate to what the user is doing at that moment or that day and what the user is thinking about. Microbloggers often post about their experiences with products and services. A microblogger may complain that his television has stopped working or that his digital video recorder (DVR) is stuck on the wrong time zone. This type of information has particular value to the vendors of the television and DVR. In addition, microbloggers may provide other information about their lives that allow inferences about the customer's problems. Examples of microblogs include the Google Buzz, Facebook status update, Twitter, and Tumblr.

Another form of a social network service is a traditional blog. A blog may relate to any variety of topics often in the form of a personal diary of commentary. Blogs may be accessed by a URL. In addition, some blog hosts provide usernames for user. Examples of blog hosts are Blogger, Wordpress, and Blogspot. Other hosts may be used, such as individually assigned websites.

Another form of a social network service is a community forum. Community forums include any message board where users share ideas and comments. Some community forums focus on a particular product or company. For example, there are message boards related to particular models of cell phone, laptops, and other products. Some companies may host a message board related to the company's products.

A location based social network service utilizes global positioning systems (GPS) to incorporate users' real world locations into the social network. For example, location based social network services may be access via a GPS enabled mobile device, which may be a cellular phone, a laptop computer, a smart phone, a tablet device, or a personal digital assistant (PDA). Users may comment from the mobile device regarding the products or services available at the users' current locations. The vendors at the users' location may offer coupons or specials to the users. An example of a location based social network service is Foursquare. A location based social network service may integrate with another social network service such as Facebook.

Another form of a social network service is a business oriented social network service, which allows users to maintain a list of contact details of people they know and trust in business and maintain a profile of the user's own business experience. The business oriented social network service may also allow users to post messages. An example of a business oriented social network service is LinkedIn.

Many secondary social network applications provide combined access to one or more of the above social network services. For example, Tweetdeck is an application for Twitter, Facebook, LinkedIn, Google Buzz, Foursquare, and MySpace. In addition, mobile clients such as Tweetie provide similar functionality of smart phones or tablet devices. The embodiments discussed above may include use of secondary social network applications on agent device 41.

Various embodiments described herein can be used alone or in combination with one another. The foregoing detailed description has described only a few of the many possible implementations of the present invention. For this reason, this detailed description is intended by way of illustration, and not by way of limitation.

I(We) claim:

1. A method comprising:
monitoring at least one social medium to identify a social media post by a customer on the at least one social medium;
accessing a database storing a plurality of agent identities;
searching the at least one social medium for a reply to the social media post, the reply associated with one of the plurality of agent identities; and
storing the reply to the social media post.

2. The method of claim 1, further comprising:
marking the social media post by the customer as open in a workflow database when the social media post is identified; and
marking the social media post by the customer as closed in the workflow database based when reply to the social media post is stored.

3. The method of claim 1, wherein the at least one social medium is monitored based on a keyword related to at least one of a product, a company, or a service.

4. The method of claim 1, wherein the social media post is associated with one of the plurality of agent identities using a reply indicator or a subject label.

5. The method of claim 1, further comprising:
calculating statistics related to the reply to the social media post.

6. The method of claim 5, wherein the statistics include workflow duration or workflow effectiveness.

7. The method of claim 1, further comprising:
filtering social media posts according to a configurable time range.

8. The method of claim 1, further comprising:
filtering social media posts according to a relevance factor based on keyword probabilities.

9. An apparatus, comprising:
a communication interface operable to receive a passive customer service request by monitoring a social networking service;
a database storing one or more agent identities associated with the customer identity; and
a controller configured to query at least one social networking service using the one or more agent identities.

10. The apparatus of claim 9, wherein a reply post associated with the one or more agent identities is downloaded from the at least one social networking service.

11. The apparatus of claim 10, wherein the controller is configured to calculate the difference between a first timestamp associated with the passive customer service request and a second timestamp associated with the reply post.

12. The apparatus of claim 9, wherein the controller is further configured to filter social media postings according to at least one of time range of the social media postings, a relevance factor of the social media postings, and a product identity.

13. The apparatus of claim 9, wherein the controller interleaves the passive customer service request and a reply post regardless of source and time.

14. Logic encoded in one or more non-transitory tangible media, the logic executable by a processor and operable to:
access a database storing a plurality of agent identities and a plurality of customer identities;
monitor at least one social medium to identify a social media post associated with one of the customer identities;
open a workflow based on the social media post;
monitor the at least one social medium to identify a social media reply associated with one of the agent identities; and
close the workflow based on the social media reply.

15. The logic of claim 14, wherein the at least one social medium is monitored based on a keyword related to at least one of a product, a company, or a service.

16. The logic of claim 14, wherein the social media post is associated with one of the plurality of agent identities using at least one of an at symbol, a username, or a subject label.

17. The logic of claim 14, further operable to:
report statistics based on a timestamp of the social media reply.

18. The logic of claim 17, wherein the statistics include average reply time by agent identity.

19. The logic of claim 17, wherein the statistics include a percentage of subsequent customer service requests.

20. The logic of claim 14, filtering the at least one social media posting according to a relevance factor of the at least one social media posting.
